(19) United States
(12) Patent Application Publication
(10) Pub. No.: US 2024/0054475 A1
(43) Pub. Date: Feb. 15, 2024

(54) SERVER APPARATUS, PURCHASE MANAGEMENT METHOD, AND RECORDING MEDIUM

(71) Applicant: NEC Corporation, Minato-ku, Tokyo (JP)

(72) Inventors: Rumi IKEZAWA, Tokyo (JP); Manabu HIKIN, Tokyo (JP)

(73) Assignee: NEC Corporation, Minato-ku, Tokyo (JP)

(21) Appl. No.: 17/766,304

(22) PCT Filed: Oct. 12, 2020
(86) PCT No.: PCT/JP2020/038432

§ 371 Date: Apr. 4, 2022

(30) Foreign Application Priority Data
Oct. 21, 2019 (JP) 2019-191759

(51) Int. Cl. G06Q 20/32; G06Q 30/0601; G06Q 20/40; G06Q 20/34

(52) U.S. Cl. CPC G06Q 20/3276; G06Q 30/0633; G06Q 20/40145; G06Q 20/34

(57) ABSTRACT

A server apparatus receives item identification information scanned from a code attached to an item from a mobile terminal, and creates a list of items to be purchased. At a time of a checkout, the server apparatus determines whether or not an item requiring an age confirmation is included in the list of items to be purchased, and transmits an age confirmation screen to the mobile terminal when the item requiring the age confirmation is included. The server apparatus performs the age confirmation based on age confirmation information received from the mobile terminal. When the age is successfully confirmed, a credit payment using the mobile terminal becomes possible.

### TECHNICAL FIELD

The present invention relates to a technical field of a product sales system using a mobile terminal.

### BACKGROUND ART

As a product sales system for a customer who has come to a store to purchase a product, a system is known in which the customer scans a barcode of the product, conducts an item registration, and makes a payment by using a mobile terminal such as a smartphone possessed by the customer. For instance, Patent Document 1 discloses a self-shopping system including a mobile terminal which acquires item information of each of items to be purchased and transmits payment information including all sets of the acquired item information to the management server, and a management server which generates and outputs sorted detail information in which item names are listed in descending order of price based on the item information included in the payment information.

Goods sold in stores include alcoholic beverages, cigarettes, and other products, which are prohibited from being sold to persons under a specified age by law. Accordingly, in a case of selling these products, it is necessary to confirm an age of a purchaser. Patent Document 2 describes a method for transmitting a facial image of a customer captured at a self-checkout register to a terminal apparatus operated by a clerk and remotely confirming an age of the customer.

### PRECEDING TECHNICAL REFERENCES

### Patent Document

Patent Document 1: Japanese Laid-open Patent Publication No. 2013-41354
Patent Document 2: International Publication Pamphlet No. WO2018/088062

### SUMMARY

### Problem to be Solved by the Invention

In recent years, it has become possible for customers to pay by a credit payment using their own mobile terminals such as smartphones or the like without using a cash register of a store. However, in a case where items for a customer to be purchased include an item which requires the age confirmation, a problem is how to confirm the age.

An object of the present invention is to correctly confirm the age in a case where a customer operates a mobile terminal of the customer to make a payment.

### Means for Solving the Problem

According to an example aspect of the present invention, there is provided a server apparatus including:
an item identification information acquisition unit configured to receive item identification information scanned from a code attached to an item, from a mobile terminal;
a list creation unit configured to create a list of items to be purchased based on the item identification information received from the mobile terminal; an age confirmation screen generation unit configured to determine whether or not an item requiring an age confirmation is included in the list of items to be purchased, generate an age confirmation screen, and transmit the age confirmation screen to the mobile terminal;
an age confirmation unit configured to perform the age confirmation based on age confirmation information received from the mobile terminal;
a payment screen generation unit configured to generate a payment screen based on the list of items to be purchased, and transmit the payment screen to the mobile terminal; and
a payment unit configured to receive payment information from the mobile terminal, and perform a payment process.

According to another example aspect of the present invention, there is provided a purchase management method performed by a server apparatus, the purchase management method including:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting an age confirmation screen to the mobile terminal when the item requiring the age confirmation is included;
performing the age confirmation based on age confirmation information received from the mobile terminal;
generating a payment screen based on the list of items to be purchased, and transmitting the payment screen to the mobile terminal, when the age confirmation is successful; and
receiving payment information from the mobile terminal, and perform a payment process.

According to still another example aspect of the present invention, there is provided a recording medium storing a program, the program causing a computer to perform a process including:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting an age confirmation screen to the mobile terminal when the item requiring the age confirmation is included;
performing the age confirmation based on age confirmation information received from the mobile terminal;
generating a payment screen based on the list of items to be purchased, and transmitting the payment screen to the mobile terminal, when the age confirmation is successful; and
receiving payment information from the mobile terminal, and perform a payment process.

According to a further example aspect of the present invention, there is provided a server apparatus including:
an item identification information acquisition unit configured to receive item identification information scanned from a code attached to an item, from a mobile terminal;
a list creation unit configured to create a list of items to be purchased based on the item identification information received from the mobile terminal; an age confirmation screen generation unit configured to determine whether or not an item requiring an age confirmation is included in the list of items to be purchased, generate and transmit an age confirmation screen to the mobile terminal when the item requiring the age confirmation is included;
an age confirmation result reception unit configured to receive an age confirmation result from the mobile terminal;
a payment screen generation unit configured to generate a payment screen based on the list of items to be purchased when the received age confirmation result is successful, and transmit the payment screen to the mobile terminal; and a payment unit configured to receive payment information from the mobile terminal, and perform a payment process.

According to still further example aspect of the present disclosure, there is provided a server apparatus including:
an item identification information acquisition unit configured to receive item identification information scanned from a code attached to an item, from a mobile terminal;
a list creation unit configured to create a list of items to be purchased based on the item identification information received from the mobile terminal; an age confirmation screen generation unit configured to determine whether or not an item requiring an age confirmation is included in the list of items to be purchased, generate and transmit an age confirmation screen to the mobile terminal when the item requiring the age confirmation is included;
an age confirmation result reception unit configured to receive an age confirmation result from the mobile terminal;
a payment screen generation unit configured to generate a payment screen based on the list of items to be purchased when the received age confirmation result is successful, and transmit the payment screen to the mobile terminal; and
a payment unit configured to receive payment information from the mobile terminal, and perform a payment process.

According to yet still another example aspect of the present disclosure, there is provided a recording medium storing a program, the program causing a computer to perform a process including:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting the age confirmation screen to the mobile terminal when the item requiring the age confirmation is included;
receiving an age confirmation result from the mobile terminal;
generating a payment screen based on the list of items to be purchased when the received age confirmation result is successful, and transmitting the payment screen to the mobile terminal; and
receiving payment information from the mobile terminal, and performing a payment process.

### Effect of the Invention

According to the present disclosure, it becomes possible to correctly confirm an age of a customer in a case where the customer makes a payment using a mobile terminal of the customer.

### BRIEF DESCRIPTION OF THE DRAWINGS

FIG. 1 illustrates a configuration of a purchase management system according to example embodiments.

FIG. 2 illustrates a schematic configuration of a POS server.

FIG. 3 illustrates a schematic configuration of a management server.

FIG. 4 illustrates a schematic configuration of a mobile terminal.

FIG. 5 illustrates a flowchart of a product purchase process

FIG. 6 is a flowchart of a store entry process.

FIG. 7 is a flowchart of an item selection process.

FIG. 8 illustrates a display example of an items-to-be-purchased list screen

FIG. 9 is a flowchart of a first example embodiment of a checkout process.

FIG. 10 is a display example of an age confirmation screen.

FIG. 11A and FIG. 11B are display examples of a credit payment screen and a checkout end screen.

FIG. 12 is a flowchart of a second example embodiment of the checkout process

### EXAMPLE EMBODIMENTS

In the following, example embodiments will be described with reference to the accompanying drawings.

[Configuration of a Purchase Management System]

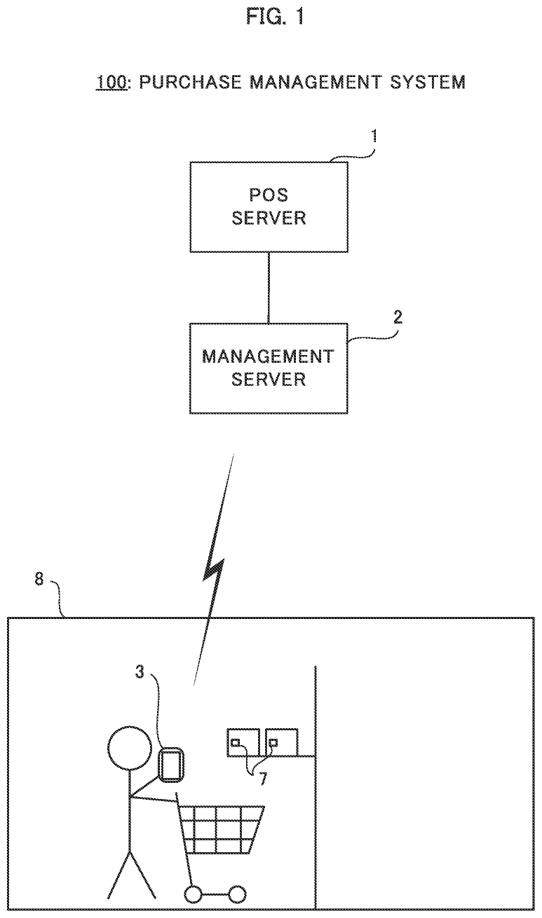

FIG. 1 illustrates a configuration of a purchase management system 100 according to a present example embodiment. The purchase management system 100 mainly includes a POS server 1, a management server 2, and a mobile terminal 3. In the purchase management system 100, a customer using the mobile terminal 3 performs registration of items to be purchased (also referred to as an “items-to-be-purchased”) by scanning an item barcode 7 attached to each item in a store 8 for selling goods, and makes a payment using a credit card payment (online payment) using the mobile terminal 3.

The POS server 1 is a server that manages various sales information such as prices concerning goods for sale in the store 8, product information including an inventory status, and the like. The POS server 1 can communicate with the management server 2 via a network or the like. Incidentally, the POS server 1 may be one that collectively manages sales information of a plurality of affiliated stores, or may be present for each store and manage only the sales information of the store.

Management server 2 is a server apparatus for controlling the mobile terminal 3, and can communicate with the mobile terminal 3 via a network or the like. The management server 2 acquires and stores information necessary for display controls of the mobile terminal 3 from the POS server 1. The management server 2 transmits display information to the mobile terminal 3 in order to display various screens on the mobile terminal 3. The above-described various screens include a screen (also referred to as an “items-to-be-purchased list screen”) for displaying, with a selling price, a list of items to be purchased (referred to as an “items-to-be-purchased list”), which are registered by the mobile terminal 3 scanning the item barcode 7.

The management server 2 may be formed by a plurality of server apparatuses. For instance, the management server 2 may include a server apparatus, which mainly performs an interface operation with the mobile terminal 3 such as data exchanges with the mobile terminal 3, and a server apparatus, which stores and manages various information such as information acquired from the POS server 1, the items-to-be-purchased list, and the like. In this case, the former server apparatus functions as a so-called application server, and the latter server apparatus functions as a so-called database server. In this case, these server apparatuses exchange information necessary for each to execute an allocated process via a network or the like.

The mobile terminal 3 is a mobile terminal used by a customer shopping at the shop 8, and includes a function of scanning the item barcode 7 attached to each item, a function of acquiring and displaying various screens such as an items-to-be-purchased list screen by communicating with the management server 2, and the like. Incidentally, in FIG. 1, for convenience of explanation, only one mobile terminal 3 is depicted; however, actually, the mobile terminals 3 for the number of customers entering the store 8 are represented.

[Configurations of Apparatuses]

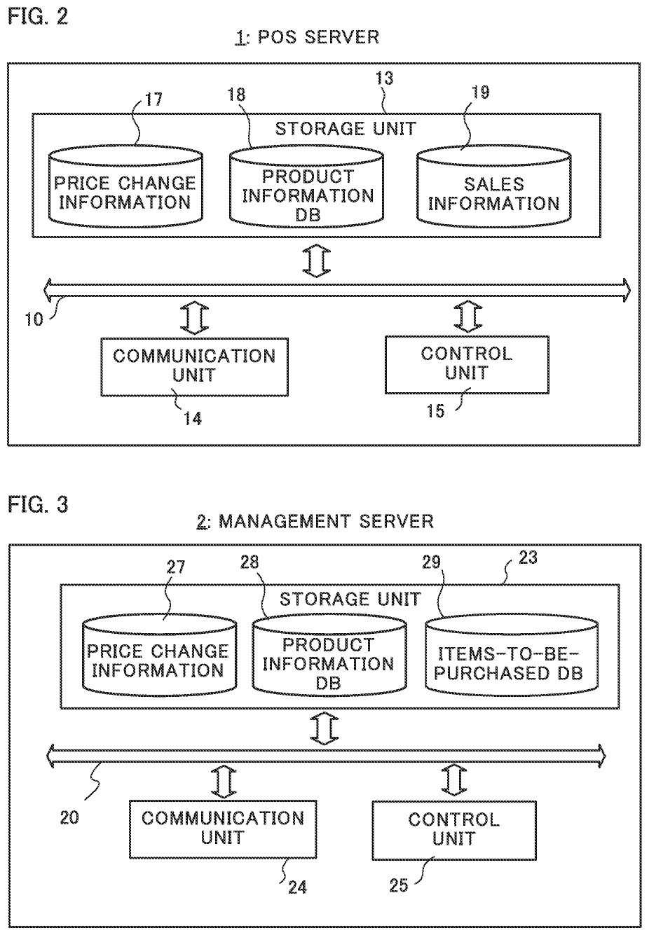

Next, configurations of the POS server 1, the management server 2, and the mobile terminal 3 will be described with reference to FIG. 2 to FIG. 4.

(POS Server)

FIG. 2 illustrates a schematic configuration of the POS server 1. The POS server 1 mainly includes a storage unit 13, a communication unit 14 for performing data communication, and a control unit 15. These elements are mutually connected via a bus line 10.

The storage unit 13 is formed by a memory such as a hard disk or a flash memory. The storage unit 13 stores a program to be executed by the control unit 15, and the information necessary for the control unit 15 to execute a predetermined process by executing a program. In the present example embodiment, the storage unit 13 includes price change information 17, a product information DB (Database) 18, and sales information 19 being information related to sales of goods. Incidentally, the storage unit 13 may store information related to various sales other than the price change information 17, the product information DB 18, and the sales information 19.

The product information DB 18 is a database of information concerning the goods handled by the store 8 or affiliated stores including the store 8. The product information DB 18 includes, for instance, various information such as information (also referred to as “item identification information”) for identifying a product such as a product price and a JAN (Japanese Article Number) code, classification information of a product, an inventory status of the product, and the like. Incidentally, for items such as alcoholic beverages and cigarettes (hereinafter referred to as an “age confirmation item”), which cannot be sold to persons under a specified age by law, a specific code or the like, which indicates such a type of an item, is applied to the item identification information, so as to be possible to determine whether or not the item is an age confirmation item by referring to the item identification information.

The price change information 17 is information related to a price change. Specifically, the price change information 17 includes at least one of arbitrary discount information or discount information such as classification specific sales discount information, bundle discount information, set discount information, total discount information, and classification specific price discount information.

The control unit 15 includes a CPU (Central Processing Unit) (not illustrated), a ROM (Read Only Memory) and a RAM (Random Access Memory), and the like, and performs various controls with respect to each of configuration elements in the POS server 1. For instance, the control unit 15 performs an update or the like of the sales information 19 by communicating with the management server 2 and each mobile terminal 3 via the communication unit 14. Also, the control unit 15 transmits information related to the price change information 17 and the product information DB 18 to the management server 2 by communicating with the management server 2 via the communication unit 14.

(Management Server)

FIG. 3 illustrates a schematic configuration of the management server 2. The management server 2 mainly includes a storage unit 23, a communication unit 24, and a control unit 25. These elements are mutually connected to each other via a bus line 20.

The storage unit 23 is formed by a memory such as a hard disk or a flash memory. The storage unit 23 stores a program to be executed by the control unit 25, and the information necessary for the control unit 25 to execute a predetermined process by executing a program. In the present example embodiment, the storage unit 23 stores a price change information 27, a product information DB 28, and an items-to-be-purchased list DB 29.

The price change information 27 is information related to a change in the price due to a price discount or a sales discount, similar to the price change information 17. The price change information 27 is periodically or irregularly updated in accordance with controls of the control unit 25, so as to synchronize with the price change information 17 stored in the POS server 1. The product information DB 28 is a database of information concerning goods, similar to the product information DB 18. The product information DB 28 is periodically or irregularly updated to synchronize with the product information DB 18 stored in the POS server 1 in accordance with controls of the control unit 25.

The items-to-be-purchased list DB 29 is a database of items-to-be-purchased lists for each of the mobile terminals 3 of customers who are shopping at stores 8. For instance, the items-to-be-purchased list is regarded as a list which includes item identification information indicating an item to be purchased, and a quantity of the item to be purchased, and is associated with information (referred to as “customer identification information”), which identifies the mobile terminal 3 or the customer using the mobile terminal 3. In addition, the items-to-be-purchased list is updated every time an addition, a deletion, or a quantity change of the items-to-be-purchased occurs based on the operation of the mobile terminal 3.

The communication unit 24 communicates with the POS server 1 and each mobile terminal 3 through wired or wireless communications. The control unit 25 includes a CPU, a ROM and a RAM, and the like, which are not illustrated, and performs various controls with respect to each of configuration elements in the management server 2. Processes executed by the control unit 25 will be described later. In the above configuration, the communication unit 24 corresponds to examples of an item identification information acquisition unit, a checkout request reception unit, and an age confirmation result reception unit, and the control unit 25 corresponds to examples of a list creation unit, an age confirmation screen generation unit, an age confirmation unit, a payment screen generation unit, a payment unit, and an end screen generation unit.

(Mobile Terminal)

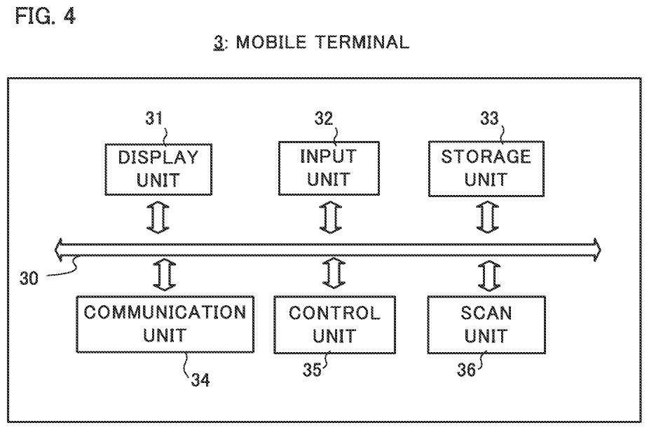

FIG. 4 illustrates a schematic configuration of the mobile terminal 3. The mobile terminal 3 mainly includes a display unit 31, an input unit 32, a storage unit 33, a communication unit 34, a control unit 35, and a scan unit 36. These elements are mutually connected to each other via a bus line 30.

The display unit 31 displays various information such as an items-to-be-purchased list screen, an age confirmation screen, a payment screen, a checkout end screen, or the like in accordance with controls of the control unit 35. The input unit 32 is an interface to accept an input from a user, and corresponds to, for instance, a touch panel, a button, a voice input device, or the like.

The storage unit 33 is formed by a memory such as a hard disk or a flash memory. The storage unit 33 stores a program to be executed by the control unit 35, and information necessary for the control unit 35 to perform a predetermined process by executing a program. For instance, the storage unit 33 stores a dedicated application program, which is started when shopping is performed at the shop 8 and which controls a display of various screens such the items-to-be-purchased list screen and the like.

The communication unit 34 communicates with the management server 2 through wireless communications. The control unit 35 includes a CPU, a ROM and a RAM, and the like, which are not illustrated, and performs various controls for each of configuration elements in the mobile terminal 3. Controls conducted by the control unit 35 will be described later.

The scan unit 36 is, for instance, an optical device such as a camera, scans the item barcode 7 attached to each item, and supplies the scanned information to the control unit 35. In the present example embodiment, the control unit 35 acquires item identification information such as the JAN code from the item barcode 7 attached to each item based on information output by the scan unit 36. Also, in a case of confirming an age by biometric information, the scan unit 36 generates the biometric information such as a face image, a fingerprint, or the like of the customer. In the above configuration, the display unit 31 is an example of the age confirmation screen display unit, and the control unit 35 corresponds to an example of an age confirmation process unit.

[Product Purchase Process]

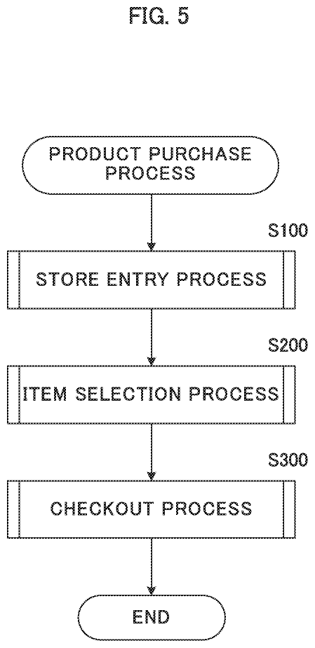

Next, an outline of a product purchase process by the purchase management system 100 will be described. The product purchase process is a process in which a customer purchases a product using the mobile terminal 3 in the store 8. FIG. 5 is a flowchart illustrating an outline of the product purchase process. The product purchase process is roughly divided into a store entry process S100, an item selection process S200, and a checkout process S300. Note that the product purchase process is realized by mainly the management server 2 and the mobile terminal 3 executing respective programs prepared in advance.

(Store Entry Process)

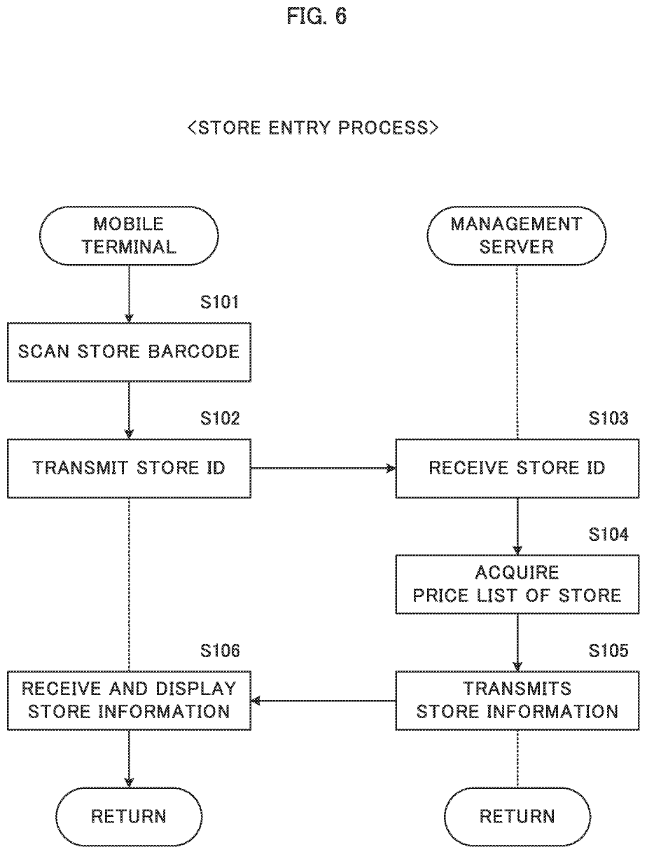

First, a store entry process will be described. The store entry process is a process, which is performed prior to a purchase of a product, when a customer enters the store 8, which corresponds to preparation for the purchase of the product. FIG. 6 is a flowchart illustrating an example of the store entry process. The store entry process is performed by the mobile terminal 3 and the management server 2.

First, when the customer enters the store 8, the customer scans a store barcode using the mobile terminal 3 (step S101). The store barcode is attached at a predetermined location in the store 8, for instance, a wall near an entrance of the store or a card used for shopping. When the customer scans the store barcode, the mobile terminal 3 acquires a store ID from the scanned store barcode and transmits the store ID to the management server 2 (step S102). In a case of transmitting the store ID, the mobile terminal 3 transmits the customer identification information, which identifies the mobile terminal 3 or the customer using the mobile terminal 3, together with the store ID. Noted that even in the item selection process and the checkout process described below, when the mobile terminal 3 basically transmits some information to the management server 2, the mobile terminal 3 also transmits the customer identification information for identifying itself with the information.

The management server 2 receives the store ID from the mobile terminal 3 (step S103) and acquires a price list of the store from the product information DB 28 (step S104). This is because prices of goods differ for each store. After that, the management server 2 transmits store information including a store name and sale information of the store to the mobile terminal 3 (step S105), and the mobile terminal 3 receives the store information (step S106). By this store entry process, a current store name, the sale information of the store, and the like are displayed on the display unit 31 of the mobile terminal 3, and the customer can start shopping. The store information, which the management server 2 sends, includes information indicating a transaction status of the customer in the store, and the transaction status becomes new when a new shopping is started at the store. On the other hand, in a case where the customer has interrupted shopping at the store for some reason, an items-to-be-purchased list screen corresponding to the transaction status up to that point is displayed on the mobile terminal 3.

(Item Selection Process)

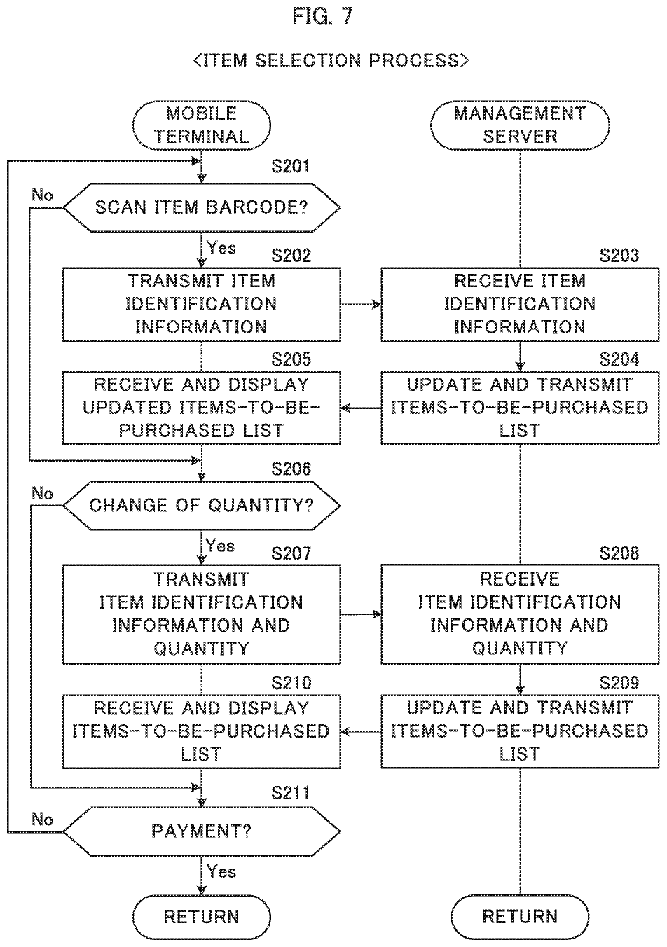

Next, an item selection process will be described. The item selection process is a process in which the customer scans the item barcode 7 attached to each item using the mobile terminal 3 and registers item information in the items-to-be-purchased list. FIG. 7 is a flowchart of the item selection process. This process is executed by the mobile terminal 3 and the management server 2.

First, when a customer finds an item desired to purchase, the customer sets the mobile terminal 3 to an item scan mode, and scans the item barcode 7 attached to the item by the mobile terminal 3 (step S201: Yes). The mobile terminal 3 transmits item identification information of the scanned item to the management server 2 (step S202). At this time, a quantity of the item is automatically set to “1”. When receiving the item identification information from the mobile terminal 3 (step S203), the management server 2 updates and transmits the items-to-be-purchased list to the mobile terminal 3 (step S204). The mobile terminal 3 receives and displays the updated items-to-be-purchased list on the display unit 31 (step S205). Accordingly, newly added items and respective quantities are additionally recorded to the items-to-be-purchased list and displayed on the mobile terminal 3.

Next, when the customer operates the mobile terminal 3 to change a quantity of the item as needed, the mobile terminal 3 acquires the changed quantities (S206 of steps: Yes). When an item barcode is first scanned, the quantity of that product is automatically set to be “1”; however, in a case where a customer purchases multiple same items, the quantity can be changed upon operating the mobile terminal 3. When the changed quantity is set, the mobile terminal 3 transmits the item identification information of the item of which quantity is changed and the changed quantity to the management server 2 (step S207).

When receiving the item identification information and the changed quantity from the mobile terminal 3 (step S208), the management server 2 updates the items-to-be-purchased list and transmits the items-to-be-purchased list to the mobile terminal 3 (step S209). The mobile terminal 3 receives the updated items-to-be-purchased list and displays the updated items-to-be-purchased list on the display unit 31 (S210 of steps). Accordingly, the change in quantity is reflected in the items-to-be-purchased list.

Next, the mobile terminal 3 determines whether a payment button 45 is pressed by the customer (step S211). The payment button 45 is a button to be pushed when the customer finishes shopping. When the payment button 45 is not pressed (step S211: No), the item selection process returns to step 201. Accordingly, until the payment button 45 is pressed, the customer can add an item or change the quantity, and continue shopping. After that, when the payment button 45 is pressed (step S211: Yes), the item selection process is terminated.

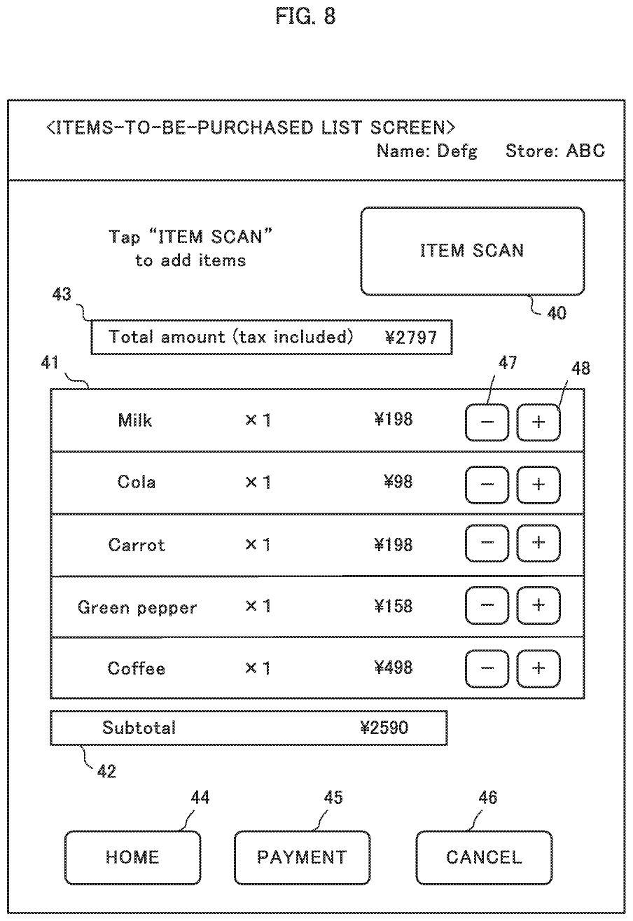

FIG. 8 illustrates a display example of the items-to-be-purchased list screen displayed on the mobile terminal 3. In this example, the items-to-be-purchased list screen includes an item scan button 40, a list display column 41, a subtotal display column 42, a total amount display column 43, a home screen transition button 44, the payment button 45, and a transaction cancel button 46.

When detecting that the item scan button 40 is selected by a tap operation or the like, the mobile terminal 3 switches a display of the display unit 31 to the item scan screen. In the item scan screen, the mobile terminal 3 displays an image or the like acquired from the started scan unit 36. Accordingly, the customer moves the item or the mobile terminal 3 so that the item barcode 7 is positioned within a scan range of the scan unit 36, and scans the item barcode 7.

For each of the items-to-be-purchased, a name, a quantity, and a price of the items-to-be-purchased are displayed in the list display column 41. Also, for each of the items-to-be-purchased in the list display column 41, a quantity decrease button 47, and a quantity increase button 48 are displayed. After that, in a case where the mobile terminal 3 receives a quantity change for the items-to-be-purchased by an operation of the quantity decrease button 47 or the quantity increase button 48, and the mobile terminal 3 transmits the item identification information of the items-to-be-purchased for which a quantity has been changed, and the changed quantity to the management server 2.

The subtotal display column 42 displays a subtotal amount without tax with respect to selling prices for all items in the items-to-be-purchased list, and the total amount display column 43 displays a total amount including tax with respect to the selling prices for all items in the items-to-be-purchased list. The management server 2 calculates the subtotal amount or the total amount based on prices of items-to-be-purchased registered in the product information DB 28, specifically, a selling price list of the store acquired by the store entry process.

When detecting that the home screen transition button 44 is selected, the mobile terminal 3 transmits a display request of a home screen to the management server 2 and displays a predetermined home screen based on display information received as a response. The home screen may be one that displays a discount and discount information at the store 8, registration information of a customer of the mobile terminal 3, and the like.

When detecting that the payment button 45 is selected, the mobile terminal 3 transmits a checkout request to the management server 2. Accordingly, the item selection process is terminated, the mobile terminal advances to the checkout process. Also, when detecting that the transaction cancel button 46 has been selected, the mobile terminal 3 transmits information to report a transaction cancel to the management server 2. In this case, the management server 2 deletes the items-to-be-purchased list corresponding to the mobile terminal 3.

(Checkout Process)

Next, a checkout process will be described. The checkout process is a process for paying items selected by the customer through the item selection process. In the present example embodiment, the customer operates the mobile terminal 3 to pay using a credit card. The customer may register credit card information at a member registration or the like for a store operation company or may register the credit card information for a payment agency with which the store has a contract, so as to be able to make a credit payment using the mobile terminal 3 of the customer.

Also, in the checkout process, age confirmation is performed if necessary. Goods sold at stores include the age confirmation item that cannot be sold to persons under a specified age by law, such as alcoholic beverages, cigarettes, and the like. Accordingly, in a case where items to be purchased by the customer include the age confirmation item, an age confirmation must be performed at a time of checkout. In the present example embodiment, this age confirmation is performed by the mobile terminal 3 of the customer. Incidentally, whether or not each item is the age confirmation item can be determined based on the item identification information. Specifically, in the first method, for the age confirmation item, a specific code is included in the item identification information. The management server 2 may store the specific code indicating the age confirmation item, refer to the item identification information of the items-to-be-purchased, and determine that the item corresponds to the age confirmation item when the specific code is included. In a second method, a list of the item identification information of the age confirmation item (hereinafter referred to as an “age confirmation item list”) is prepared in advance. The management server 2 may store the age confirmation item list in advance, refer to the age confirmation item list, and determine that the item to be purchased corresponds to the age confirmation item when the item identification information of the item to be purchased is included in the age confirmation item list.

### First Example Embodiment

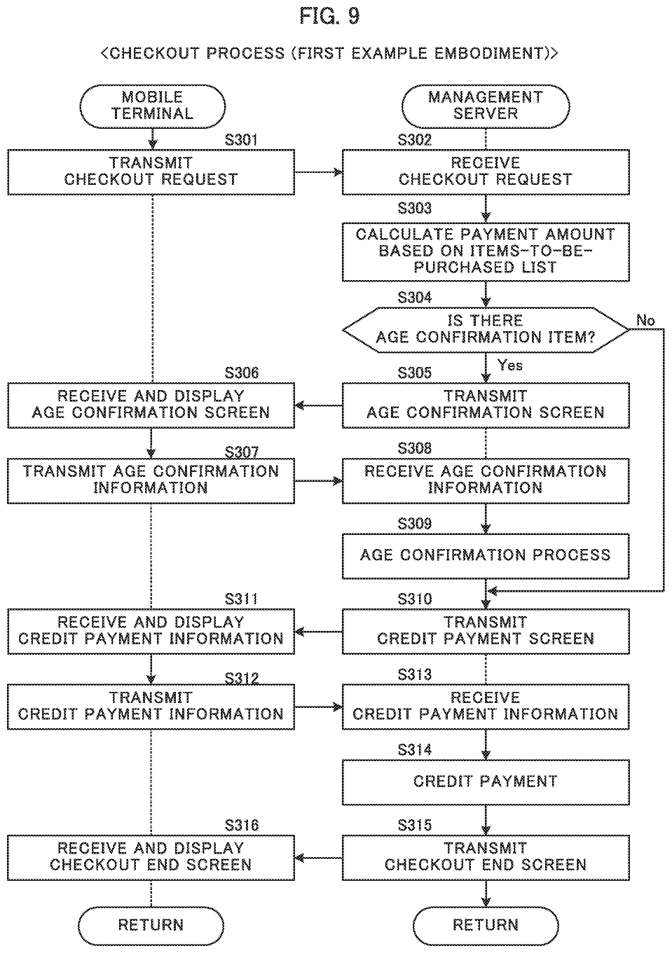

FIG. 9 is a flowchart of a first example embodiment of the checkout process. This process is executed by the mobile terminal 3 and the management server 2. First, when the payment button 45 described above is pressed, the mobile terminal 3 transmits a checkout request to the management server 2 (step S301). When receiving the checkout request (step S302), the management server 2 calculates a payment amount based on the items-to-be-purchased list at that time (step S303). Next, the management server 2 refers to the items-to-be-purchased list and determines whether or not the items to be purchased include the age confirmation item (step S304). When the age confirmation item is not included (step S304: No), the process proceeds to the step S310 described later. On the other hand, when the age confirmation product is included (step S304: Yes), the management server 2 generates and transmits an age confirmation screen to the mobile terminal 3 (step S305). The mobile terminal 3 receives the age confirmation screen from the management server 2, and displays the age confirmation screen on the display unit 31 (step S306).

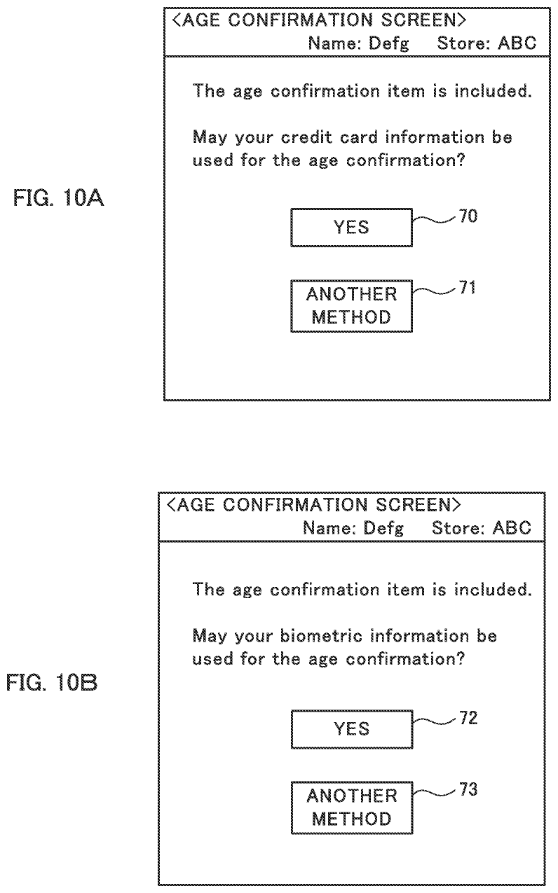

The age confirmation can be carried out using several methods. FIG. 10A is a display example of the age confirmation screen in a case of performing the age confirmation using credit card information as age confirmation information. Normally, in a case of issuing a credit card, a credit company verifies identity of a credit card holder by a driver's license, or the like, and an age of the credit card holder has been proven. Accordingly, for the verified credit card holder, it is possible to perform the age confirmation based on the credit card information. In an example in FIG. 10A, the customer can perform the age confirmation using the credit card information of the customer by pressing a button 70. On the other hand, the customer can also select another age confirmation method by pressing a button 71. Incidentally, even in addition to the credit card, for instance, in a case where the customer possesses a member card with a credit function (point card) or has a member registration that can be enrolled on a condition of an age confirmation, such the information may be used to confirm the age of the customer.

FIG. 10B is a display example of the age confirmation screen in a case of confirming an age using the biometric information of the customer as the age confirmation information. In this case, the biometric information (a face, a fingerprint, or the like) of the customer is registered in advance at a time of the member registration of the customer, or the like. In a case of displaying the age confirmation screen, the customer uses the mobile terminal 3 to generate biometric information of the customer (such as a facial image or a fingerprint) and transmits the biometric information to the management server 2. The management server 2 matches the biometric information transmitted from the mobile terminal 3 with the biometric information registered in advance, and in a case where both are matched with each other, the age confirmation may be performed based on age information of the customer registered as a member. In the example in FIG. 10B, by pressing a button 72, the customer can perform the age confirmation using the biological information of the customer. Instead, the customer can also select another age confirmation method by pressing a button 73.

Due to operations on the age confirmation screen, the mobile terminal 3 acquires the age confirmation information according to the age confirmation method selected by the customer, and transmits to the management server 2 (step S307). The management server 2 receives the age confirmation information from the mobile terminal 3 (step S308), and performs the age confirmation using the age confirmation information (step S309). Note that in a case where the age confirmation fails based on the received age confirmation information, the management server 2 may re-transmit the age confirmation screen indicating that an age confirmation fails in order for the customer to receive an opportunity to retry; however, in a case where the age confirmation fails even after a predetermined number of retries, the transaction is cancelled.

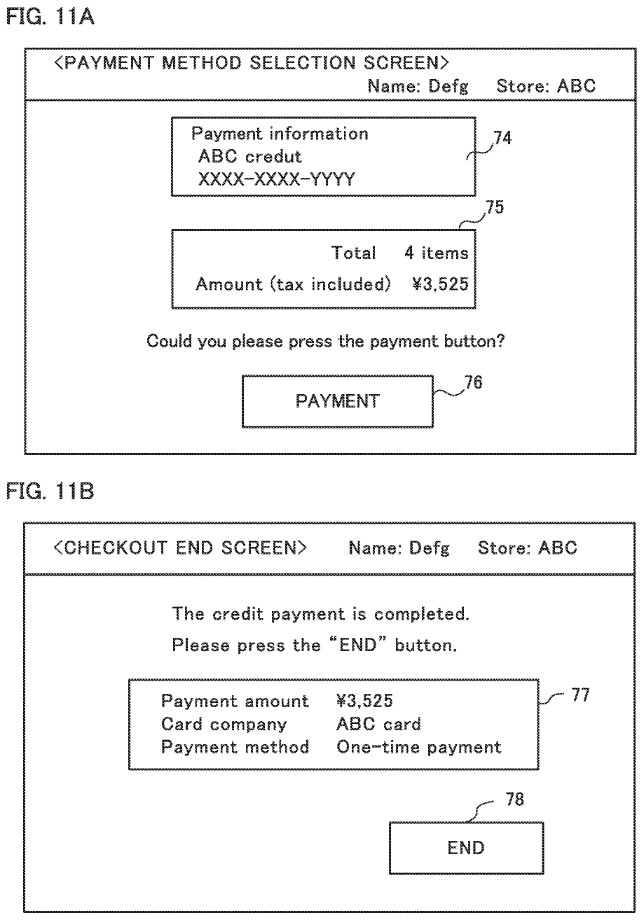

When the age confirmation is successful in step S309, the management server 2 proceeds to a credit payment. Specifically, the management server 2 transmits a credit payment screen to the mobile terminal 3 (step S310). The mobile terminal 3 receives and displays the credit payment screen on the display unit 31. FIG. 11A is a display example of a credit payment screen. In this example, the credit payment screen includes a payment information column 74, a total amount column 75, and a payment button 76. The payment information column 74 includes a credit company name and a credit card number for making credit payments. The total amount column 75 indicates a total amount for items to be purchased. The payment button 76 is a button for the customer to instruct an execution of a credit payment. Note that an input field is provided in a case where an input of a personal identification number or a security code is required depending on a credit company, or the like.

When the customer presses the payment button 76, the mobile terminal 3 transmits the credit payment information to the management server 2 (step S312). The credit payment information includes information identifying a credit card used for payments, information indicating that the customer has agreed to the credit payment, and the like. Note that in a case of entering the personal identification number, the security code, and the like, the entered information is also included in the credit payment information and is transmitted. The management server 2 receives the credit payment information (step S313), and executes the credit payment (step S314). Note that, if necessary, the management server 2 transmits the credit payment information to a server or the like of the credit company or the credit agent company to perform the payment process.

When the credit payment is completed, the management server 2 transmits a checkout end screen to the mobile terminal 3 (step S315). The mobile terminal 3 receives and displays the checkout end screen on the display unit 31 (step S316). FIG. 11B is a display example of the checkout end screen. In this example, the checkout end screen includes a payment information column 77 and an end button 78. The payment information column 77 displays information such as a payment amount, a payment method, and the like. The end button 78 is a button for confirming that the customer has done the checkout process. When the customer presses the end button 78, the mobile terminal 3 reports to the management server 2 that the payment has been completed, and returns the display of the mobile terminal 3 to a main menu. Accordingly, the checkout process is terminated.

### Second Example Embodiment

Next, a second example embodiment of the checkout process will be described. In the first example embodiment, in a case of requiring an age confirmation, the mobile terminal 3 transmits age confirmation information to the management server 2, and the management server 2 executes an age confirmation process. Instead, in the second example embodiment, the mobile terminal 3 executes the age confirmation process. Specifically, the age confirmation information such as credit card information or biometric information is stored in advance in the mobile terminal 3. It is preferable that the age confirmation information is stored in a state protected by an encrypted method so as not to be forged or altered by a customer. In a case of requiring the age confirmation, the mobile terminal 3 prompts the customer to input age confirmation information, and performs the age confirmation process using the acquired age confirmation information and the age confirmation information already stored in the mobile terminal 3.

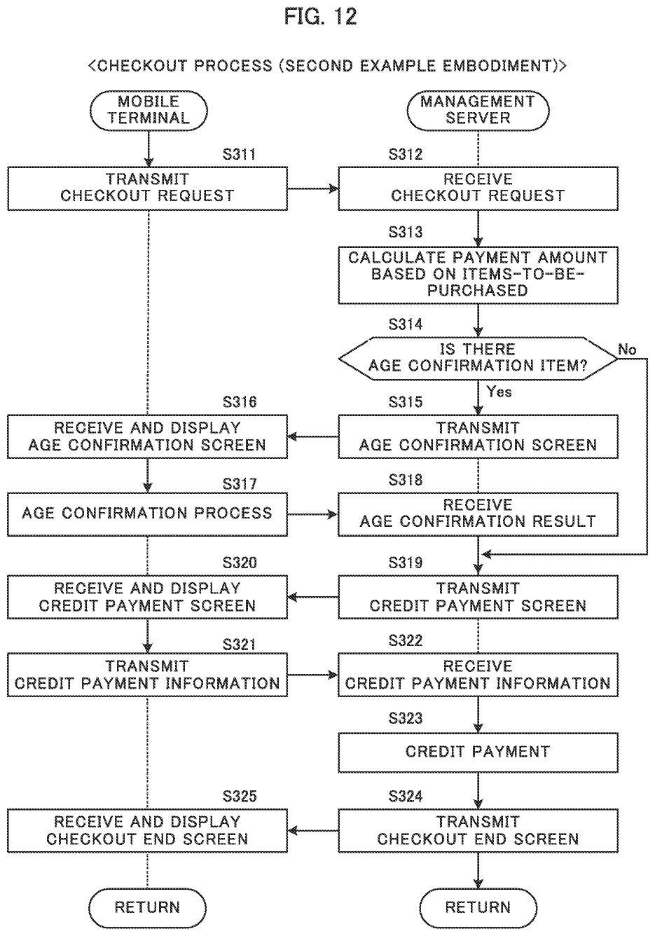

FIG. 12 is a flowchart of the second example embodiment of the checkout process. The checkout process is executed by the mobile terminal 3 and the management server 2. Steps S311 through S316 in the second example embodiment are the same as steps S301 through 306 of the first example embodiment depicted in FIG. 9. When input of age confirmation information is requested on the age confirmation screen, the customer inputs the age confirmation information. The mobile terminal 3 performs the age confirmation process using the input age confirmation information (step S317). Specifically, the mobile telephone terminal 3 matches the input age confirmation information with the age confirmation information stored in the mobile terminal 3, and the age confirmation is successful when both are matched with each other. After that, the mobile terminal 3 transmits an age confirmation result to the management server 2.

When the age confirmation result is successful, the management server 2, receives the age confirmation result from the mobile terminal 3 (step S318), and advances to step S319. Processes of steps S319 through 325 are the same as those in steps S310 through S316 of the first example embodiment depicted in FIG. 9, and explanations thereof are omitted. When the age confirmation result is unsuccessful, the management server 2 may send the age confirmation screen again in order for the customer to perform a predetermined number of retries. In addition, in a case where a final age confirmation is unsuccessful, the management server 2 may terminate the product purchase process.

As described above, in the present example embodiment, even in a case where the customer pays by a credit payment using the mobile terminal 3 of the customer, it is possible to perform the age confirmation for the age confirmation item. Accordingly, it is possible to promptly perform the age confirmation without assistance of a clerk.

[Modification]

(Modification 1)

In the above-described example embodiment, the age confirmation using the credit card information and the age confirmation using the biological information are selectively performed; however, the age confirmation by both may be a condition. Moreover, in the above example embodiment, the method of the present disclosure is applied to a system in which a payment can be made only by the credit payment using the mobile terminal; however, the method of the present disclosure can be also applied to a process in a case where the customer makes a payment using the mobile terminal in a system that supports both the payment using the mobile terminal and a payment at a checkout machine.

(Modification 2)

In the above-described example embodiment, a barcode applied to a product is scanned by the mobile terminal 3; however, instead, a QR (Quick Response) code may be applied to the product and the QR code may be scanned by the mobile terminal 3.

In addition, part or all of each of the example embodiments described above (including modifications, the same below) may also be described as the following supplementary notes, but not limited thereto.

(Supplementary Note 1)

1. A server apparatus comprising:
an item identification information acquisition unit configured to receive item identification information scanned from a code attached to an item, from a mobile terminal;
a list creation unit configured to create a list of items to be purchased based on the item identification information received from the mobile terminal;
an age confirmation screen generation unit configured to determine whether or not an item requiring an age confirmation is included in the list of items to be purchased, generate an age confirmation screen, and transmit the age confirmation screen to the mobile terminal;
an age confirmation unit configured to perform the age confirmation based on the age confirmation information received from the mobile terminal;
a payment screen generation unit configured to generate a payment screen based on the list of items to be purchased, and transmit the payment screen to the mobile terminal; and
a payment unit configured to receive payment information from the mobile terminal, and perform a payment process.

(Supplementary Note 2)

2. The server apparatus according to supplementary note 1, further comprising a checkout request reception unit configured to receive a checkout request from the mobile terminal,
wherein the age confirmation screen generation unit determines whether or not the item requiring the age confirmation is included in the list of items to be purchased when the checkout request reception unit receives the checkout request.

(Supplementary Note 3)

3. The server apparatus according to supplementary note 2, wherein the payment screen generation unit transmits the payment screen after the age confirmation performs the age confirmation when the age confirmation screen generation unit determines that the item requiring the age confirmation is included in the list of items to be purchased, and transmits the payment screen when the age confirmation screen generation unit determines that the item requiring the age confirmation is not included in the list of items to be purchased.

(Supplementary Note 4)

4. The server apparatus according to any one of supplementary notes 1 through 3, wherein the payment unit executes a payment using a credit card.

(Supplementary Note 5)

5. The server apparatus according to any one of supplementary notes 1 through 4, wherein the age confirmation information is information for requiring the age confirmation based on registration information of a credit card.

(Supplementary Note 6)

6. The server apparatus according to any one of supplementary notes 1 through 4, wherein the age confirmation information is biometric information of a customer, which is generated by the mobile terminal.

(Supplementary Note 7)

7. The server apparatus according to any one of supplementary notes 1 through 6, wherein the age confirmation screen includes a message indicating that the item requiring the age confirmation is included in the list of items to be purchased.

(Supplementary Note 8)

8. The server apparatus according to any one of supplementary notes 1 through 7, further comprising an end screen generation unit configured to generates a checkout end screen, and transmit the checkout end screen to the mobile terminal, when the payment unit completes the payment process.

(Supplementary Note 9)

9. A purchase management method performed by a server apparatus, the purchase management method comprising:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting an age confirmation screen to the mobile terminal when the item requiring the age confirmation is included;
performing the age confirmation based on age confirmation information received from the mobile terminal;
generating a payment screen based on the list of items to be purchased, and transmitting the payment screen to the mobile terminal, when the age confirmation is successful; and
receiving payment information from the mobile terminal, and perform a payment process.

(Supplementary Note 10)

10. A recording medium storing a program, the program causing a computer to perform a process comprising:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting an age confirmation screen to the mobile terminal when the item requiring the age confirmation is included;
performing the age confirmation based on age confirmation information received from the mobile terminal;
generating a payment screen based on the list of items to be purchased, and transmitting the payment screen to the mobile terminal, when the age confirmation is successful; and
receiving payment information from the mobile terminal, and perform a payment process.

(Supplementary Note 11)

11. A server apparatus comprising:
an item identification information acquisition unit configured to receive item identification information scanned from a code attached to an item, from a mobile terminal;
a list creation unit configured to create a list of items to be purchased based on the item identification information received from the mobile terminal;
an age confirmation screen generation unit configured to determine whether or not an item requiring an age confirmation is included in the list of items to be purchased, generate and transmit an age confirmation screen to the mobile terminal when the item requiring the age confirmation is included;
an age confirmation result reception unit configured to receive an age confirmation result from the mobile terminal;
a payment screen generation unit configured to generate a payment screen based on the list of items to be purchased when the received age confirmation result is successful, and transmit the payment screen to the mobile terminal; and
a payment unit configured to receive payment information from the mobile terminal, and perform a payment process.

(Supplementary Note 12)

12. A purchase management system comprising:
the server apparatus according to supplementary note 11; and
a mobile terminal,
wherein the mobile terminal includes
   a storage unit configured to store age confirmation information,
   an age confirmation screen display unit configured to receive and display the age confirmation screen from the server apparatus, and
   an age confirmation process unit configured to acquire the age confirmation information, perform the age confirmation by matching the acquired age confirmation information with the age confirmation information stored in the storage unit, and transmit the age confirmation result to the server apparatus.

(Supplementary Note 13)

13. A purchase management method performed by a server apparatus, the purchase management method comprising:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting the age confirmation screen to the mobile terminal when the item requiring the age confirmation is included;
receiving an age confirmation result from the mobile terminal;
generating a payment screen based on the list of items to be purchased when the received age confirmation result is successful, and transmitting the payment screen to the mobile terminal; and
receiving payment information from the mobile terminal, and performing a payment process.

(Supplementary Note 14)

14. A recording medium storing a program, the program causing a computer to perform a process comprising:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting the age confirmation screen to the mobile terminal when the item requiring the age confirmation is included;
receiving an age confirmation result from the mobile terminal;
generating a payment screen based on the list of items to be purchased when the received age confirmation result is successful, and transmitting the payment screen to the mobile terminal; and
receiving payment information from the mobile terminal, and performing a payment process.

This application claims priority on the basis of Japanese Patent Application No. 2019-191759 filed on Oct. 21, 2019 and incorporates all of its disclosures herein.

While the invention of the present application has been described above with reference to the example embodiments, the invention of the present application is not limited to the above-described example embodiments. Various changes that can be understood by those skilled in the art can be made within the scope of the present disclosure in terms of the configuration and details of the present disclosure. That is, it goes without saying that the invention of the present application includes all disclosure including claims, various modifications and modifications that can be made by those skilled in the art in accordance with the technical idea. In addition, each disclosure of the above cited patent documents are incorporated into this document by citation.

### DESCRIPTION OF SYMBOLS

1 POS server
2 Management server
3 Mobile terminal
100 Purchase management system

What is claimed is:

1. A server apparatus comprising:
a memory storing instructions; and
one or more processors configured to execute the instructions to:
receive item identification information scanned from a code attached to an item, from a mobile terminal;
create a list of items to be purchased based on the item identification information received from the mobile terminal;
determine whether or not an item requiring an age confirmation is included in the list of items to be purchased, generate an age confirmation screen, and transmit the age confirmation screen to the mobile terminal;
perform the age confirmation based on age confirmation information received from the mobile terminal;
generate a payment screen based on the list of items to be purchased, and transmit the payment screen to the mobile terminal; and
receive payment information from the mobile terminal, and perform a payment process.

2. The server apparatus according to claim 1, wherein the processor is further configured to receive-a checkout request from the mobile terminal,
wherein the processor determines whether or not the item requiring the age confirmation is included in the list of items to be purchased when receiving the checkout request.

3. The server apparatus according to claim 2, wherein the processor transmits the payment screen after the age confirmation performs the age confirmation when the processor determines that the item requiring the age confirmation is included in the list of items to be purchased, and transmits the payment screen when the processor determines that the item requiring the age confirmation is not included in the list of items to be purchased.

4. The server apparatus according to claim 1, wherein the processor executes a payment using a credit card.

5. The server apparatus according to claim 1, wherein the age confirmation information is information for requiring the age confirmation based on registration information of a credit card.

6. The server apparatus according to claim 1, wherein the age confirmation information is biometric information of a customer, which is generated by the mobile terminal.

7. The server apparatus according to claim 1, wherein the age confirmation screen includes a message indicating that the item requiring the age confirmation is included in the list of items to be purchased.

8. The server apparatus according to claim 1, wherein the processor is further configured to generates a checkout end screen, and transmit the checkout end screen to the mobile terminal, when the processor completes the payment process.

9. A purchase management method performed by a server apparatus, the purchase management method comprising:
receiving item identification information scanned from a code attached to an item, from a mobile terminal;
creating a list of items to be purchased based on the item identification information received from the mobile terminal;
determining whether or not an item requiring an age confirmation is included in the list of items to be purchased, and generating and transmitting an age confirmation screen to the mobile terminal when the item requiring the age confirmation is included;
performing the age confirmation based on age confirmation information received from the mobile terminal;
generating a payment screen based on the list of items to be purchased, and transmitting the payment screen to the mobile terminal, when the age confirmation is successful; and
receiving payment information from the mobile terminal, and perform a payment process.

10. (canceled)

11. A server apparatus comprising:
a first memory storing instructions; and
one or more first processors configured to execute the instructions to:
receive item identification information scanned from a code attached to an item, from a mobile terminal;
create a list of items to be purchased based on the item identification information received from the mobile terminal;
determine whether or not an item requiring an age confirmation is included in the list of items to be purchased, generate and transmit an age confirmation screen to the mobile terminal when the item requiring the age confirmation is included;
receive an age confirmation result from the mobile terminal;
generate a payment screen based on the list of items to be purchased when the received age confirmation result is successful, and transmit the payment screen to the mobile terminal; and
receive payment information from the mobile terminal, and perform a payment process.

12. A purchase management system comprising:
the server apparatus according to claim 11; and
a mobile terminal including,
a second memory storing instructions; and
one or more second processors configured to execute the instructions to:
store age confirmation information,
receive and display the age confirmation screen from the server apparatus, and
acquire the age confirmation information, perform the age confirmation by matching the acquired age confirmation information with the age confirmation information stored in the second memory, and transmit the age confirmation result to the server apparatus.

13-14. (canceled)
